(19) United States
(12) Patent Application Publication
(10) Pub. No.: US 2026/0285151 A1
(43) Pub. Date: Sep. 24, 2026

(54) DISPLAY CONTROL DEVICE

(71) Applicant: Nippon Seiki Co., Ltd., Niigata (JP)

(72) Inventor: Ryo TAKANO, Niigata (JP)

(21) Appl. No.: 19/476,023

(22) PCT Filed: May 10, 2024
(86) PCT No.: PCT/JP2024/017380

§ 371 Date: Oct. 16, 2025

(30) Foreign Application Priority Data
May 10, 2023 (JP) 2023-077986

(51) Int. Cl. B60K 35/232

(52) U.S. Cl. CPC B60K 35/232; B60K 2360/179

(57) ABSTRACT

Provided is a display control device which controls a display device for displaying content so as to be superimposed on the actual view and which has: a display information generation unit that generates first content (superimposed content) to be superimposed and displayed on a specific superimposition target present in the actual view and second content (non-superimposed content) to be superimposed and displayed on the actual view without being superimposed on the superimposition target; and a display control unit that displays the first content and the second content sequentially on the display device.

### TECHNICAL FIELD

The present invention relates to a display control device suitable for use in a head-up display device or the like mounted on a vehicle.

### BACKGROUND ART

As a display device mounted on a vehicle, a head-up display (HUD) device is known that displays a virtual image by emitting display light onto a projection member such as a windshield.

For example, Patent Document 1 describes a technique in which a display control device is used in a vehicle and controls a display by a HUD, the display control device comprising: a display generation unit that generates superimposed content, which is superimposed and displayed on a specific superimposition target present in a foreground of the vehicle, and non-superimposed content, which is superimposed and displayed on the foreground in a non-superimposed state with respect to the superimposition target; and a target position recognition unit that recognizes a distance to a specific position related to the superimposition target or a time until reaching the specific position, wherein the display generation unit causes the non-superimposed content, which has substantially the same meaning as the superimposed content, to be displayed prior to displaying the superimposed content, and based on the distance or time recognized by the target position recognition unit becoming less than a threshold, causes the superimposed content to be superimposed and displayed on the superimposition target.

### PRIOR ART DOCUMENT

### Patent Document

Patent Document 1: Japanese Unexamined Patent Application Publication No. 2022-58537 (paragraph [0006])

### SUMMARY OF THE INVENTION

### Problems to be Solved by the Invention

According to the technique described in Patent Document 1 described above, the superimposed display by the HUD is changed from non-superimposed content to superimposed content having substantially the same meaning. For this reason, even if the information presentation is started early using a HUD with a limited angle of view, misunderstanding by the user due to the change is unlikely to occur, and therefore, highly convenient information presentation becomes possible.

However, the inventors have recognized that the technique described in Patent Document 1 is insufficient, for example, in a driving situation where a danger occurs, from the viewpoint of notifying the user of the danger in an easily-understandable manner. Therefore, there is a safety issue in terms of making it possible to prepare for danger by notifying the user of a dangerous situation in advance in an easily-understandable format. Patent Document 1 makes no mention of such a problem, and does not suggest any measures to address the problem.

The present invention has been made to solve the problem described above, and an object of the present invention is to provide a display control device that, for example, makes it possible to prepare for danger by notifying a user of a dangerous situation in advance in an easily-understandable format.

Other objects of the present invention will become apparent to those skilled in the art by referring to the aspects and best mode exemplified below, and the accompanying drawings.

### Solution to Problem

Hereinafter, in order to easily understand the outline of the present invention, aspects according to the present invention will be exemplified.

In a first aspect, a display control device controls a display device that displays content so as to be superimposed on an actual view, the display control device including: a display information generation unit that generates a first content to be superimposed and displayed on a specific superimposition target present in the actual view, and a second content to be superimposed and displayed on the actual view in a non-superimposed state with respect to the superimposition target; and a display control unit that sequentially displays the first content and the second content on the display device.

Here, the “superimposition target” is, for example, a specific target present in the foreground, such as a road surface, a forward vehicle, a pedestrian, or a road sign. Furthermore, the “first content” is, for example, a visually prominent augmented reality (AR) display object (virtual image) that uses AR, and is superimposed content in which the display position is associated with a specific superimposition target present in the foreground. The “second content” is a display object other than the first content among the AR display objects superimposed and displayed on the foreground, and unlike the first content, is non-superimposed content having substantially the same meaning as the first content, and is superimposed and displayed on the foreground on a specific superimposition target in a non-superimposed manner.

According to the first aspect, the display control unit sequentially displays, on the display device, the first content, which is superimposed and displayed on a specific superimposition target present in the actual view, and the second content, which is superimposed and displayed on the actual view in a non-superimposed state with respect to the superimposition target. In other words, the amount of information provided to the user is distributed by the first content and the second content, and the first content and the second content are displayed in a stepwise fashion. As a result, for example, in a driving situation where a danger occurs, it is possible to notify the user of the danger in an easily-understandable manner with less burden on the user, thereby allowing the user to prepare for the danger.

In a second aspect which is dependent on the first aspect, the display control unit may display the second content, and then display the first content.

According to a second aspect, the first content is displayed after the second content is displayed. In this way, by providing advance notification with non-superimposed content having substantially the same meaning as the first content instead of the visually prominent first content, it is possible to transmit the necessary information while ensuring the forward visibility of the user. Therefore, it is possible to allow the user to prepare for danger by, for example, notifying the user of a dangerous situation in advance in an easily-understandable manner.

In a third aspect which is dependent on the first or second aspect, the display control unit may, even in a situation where the first content can be superimposed on the superimposition target, display the second content and then display the first content.

According to the third aspect, if the visually prominent first content is displayed first, the user will become less alert to other objects, and therefore, by displaying the second content first, the user is capable of accepting information while distributing the attention to some extent.

In a fourth aspect which is dependent on the first to third aspects, the display control unit may display the first content further away than the second content in a user's view.

According to the fourth aspect, by adopting a mode in which the user's line of sight moves from the second content, which is displayed nearby in the user's view, to the first content, which is displayed in the distance, the number of reciprocating line of sight movements can be reduced, which enables smooth viewing that facilitates easier understanding for the user.

In a fifth aspect which is dependent on the first to fourth aspects, the display device may have a first displayer and a second displayer, and the display control unit may display the first content on the first displayer, and display the second content on the second displayer.

Here, the first displayer is, for example, a HUD, and the second displayer is, for example, a windshield display (WSD) that projects an image onto a black ceramic portion of the vehicle (a black part of the windshield). According to the fifth aspect, by displaying the first content and the second content on separate displayers, a wide display area for the content can be obtained, and it is also possible to prevent the display from becoming complicated.

In a sixth aspect which is dependent on the first to fifth aspects, the display control unit may display the first content in a first mode, and display the second content in a second mode.

According to the sixth aspect, the display control unit provides advance notification with the second content (non-superimposed content) using text, icons, and the like, which allows the user to understand, for example, the nature of the danger in advance.

In a seventh aspect which is dependent on the first to sixth aspects, it is possible to include a relationship determination unit that determines a relationship between the first content and the second content, the display control unit may, in a case where the first content displayed corresponding to a first superimposition target among the specific superimposition targets, and the second content displayed corresponding to a second superimposition target, which is a specific superimposition target, for which a relationship level indicating the relationship is less than a predetermined value, are displayed simultaneously, perform a control that delays a display start timing of the second content and/or advances a display start timing of the first content.

According to the seventh aspect, when the first content of a certain superimposition target and the second content of another superimposition target are displayed simultaneously, the display control unit performs a control that delays the display start timing of the second content, or advances the display start timing of the first content, or both, which makes it possible to prevent the user from being misled into thinking that the content are related.

Here, in the determination of the relationship between the first content and the second content, for example, the relationship level is determined to be high if the superimposed content and the non-superimposed content are created for a single object being tracked by a periphery monitoring sensor. Furthermore, for example, a label can be assigned to each content, and if the matching number of labels between the superimposed content and the non-superimposed content is greater than or equal to a predetermined threshold, it can be determined that the relationship level is high. In addition, a method of calculating a correlation coefficient can also be considered.

Also, the control of the display start timing can be realized by, for example, providing a range to the display start timing setting (a timing settable range), setting a display start timing that is earlier or later than a standard display start timing, and controlling the rising edge of a blanking period (during the display period of both horizontal/vertical synchronization signals) according to the setting.

In an eighth aspect which is dependent on the first to sixth aspects, a relationship determination unit may be further included that determines a relationship between the first content and the second content, and the display control unit may, in a case where a relationship level indicating the relationship is greater than or equal to a threshold, arrange and display the first content and the second content on a straight line that connects the superimposition target and an eye point of a user when viewing the superimposition target from above.

When the user looks at the first content or the second content from the actual view on the forward side of the vehicle, the user needs to shift the eye focus (focus point) from the actual view in real space to the virtual image. According to the eighth aspect, when the relationship level is greater than or equal to a predetermined value, by arranging and displaying the first content and the second content on a straight line that connects the user's eye point when viewing the superimposition target from above (the user visually observes the first content and the second content on a single line), the movement of the user's line of sight becomes natural, and the relationship between the content can be made visually easy to understand. In other words, the movement in the user's gaze point is reduced as much as possible when the user's focus point switches from the forward actual view to the virtual image (the need for eye focus adjustment is reduced as much as possible).

In a ninth aspect which is dependent on the first to eighth aspects, a visibility determination unit may be further included that determines a visibility of a forward field of view of a vehicle, and the display control unit may control a display start timing of the first content according to a visibility level indicating the visibility.

For example, in a situation where the user's visibility is reduced due to weather changes such as rain or snow, although the superimposition target cannot be seen until the last moment, according to the ninth aspect, under such circumstances, the display control unit performs a control that advances the display start timing of the first content (in other words, advance the timing of information notification), which makes it possible to prepare for an impending danger in advance while reducing the user's mental burden.

Here, the determination of the visibility can be realized by, for example, generating feature amounts for each part that constitutes a specific subject, matching the feature amounts with those of the same subject in a preset, high-visibility situation, and then calculating a score according to the matching result. The visibility of a subject is highest when everything is clearly visible, and the area that is clearly visible becomes smaller as more of the area becomes obscured by the effects of weather changes such as rain or snow. Therefore, it is possible to estimate the extent to which each part constituting the subject is visible from the score of each part. The visibility can be evaluated using the ratio of the total area of the parts with a high score to the total area of the subject as a quantity representing how much of the subject is visible. Also, the control of the display start timing can be realized by, for example, providing a range to the display start timing setting (timing settable range), setting a display start timing that is earlier or later according to the visibility level, and controlling the rising edge of a blanking period (during the display period of both horizontal/vertical synchronization signals) according to the setting.

In a tenth aspect which is dependent on the first to ninth aspects, the display control unit may control a display start timing of the first content according to a display distance of the second content.

According to the tenth aspect, the display control unit determines the display start timing of the first content according to the display distance of the second content, which makes it possible to set a display start timing at which the line of sight movement from the second content to the first content does not become excessively large, and as a result, the user's viewing burden (burden of eye focus adjustment) can be reduced.

Here, the “display distance of the second content” is the distance from the user's eye point to the second content, and for example, the display distance is controlled by at least one of changing the optical path length from a display unit having a liquid crystal panel with a backlight or the like to the projection member (for example, the length of the optical path from a first point where the optical axis of the optical system intersects the display surface of the display unit to a second point where the optical axis intersects the projection member), or changing the display position of the second content on the display surface.

In an eleventh aspect which is dependent on the first to tenth aspects, the display control unit may control a display distance interval between the first content and the second content according to a display distance of the first content.

According to the eleventh aspect, the display control unit controls the display distance interval between the first content and the second content according to the display distance of the first content, and by setting a display distance interval at which the line of sight movement from the second content to the first content does not become excessively large, the user's viewing burden can be reduced.

In a twelfth aspect which is dependent on the first to eleventh aspects, a distance determination unit may be further included that determines a distance between an own vehicle position and the superimposition target, and the display control unit may control a display distance interval between the first content and the second content according to a distance determined by the distance determination unit.

According to the twelfth aspect, the display control unit controls the display distance interval between the first content and the second content according to the distance between the own vehicle position and the superimposition target, and by setting a display distance interval at which the line of sight movement from the second content to the first content does not become excessively large, the user's viewing burden can be reduced.

In a thirteenth aspect which is dependent on the first to twelfth aspects, a relationship determination unit may be further included that determines a relationship between the first content and the second content, and the display control unit may control the display distance interval by adjusting a display distance of the second content according to a relationship level that indicates the relationship.

According to the thirteenth aspect, for example, in a case where the display distance of the first content is d1 and the display distance of the second content is d2, the display distance of the second content is adjusted by performing control such that, if the relationship level between the first content and the second content is high, the value of d2 is increased to narrow the display distance interval, and if the relationship level is low, the value of d2 is decreased to widen the display distance interval. As a result, items in which the relationship between the first content and the second content is low are visually separated, and notifications that do not mislead the user can be realized.

In a fourteenth aspect which is dependent on the first to thirteenth aspects, the display control unit may, after the second content is displayed, perform a control that causes the second content to be non-displayed until the first content is displayed.

According to the fourteenth aspect, the display control unit, after the second content is displayed, causes the second content to be non-displayed until the first content is displayed, which makes it possible to reduce the amount of content occupying the display angle of view, which can also lead to a reduction in the user's viewing burden.

In a fifteenth aspect which is dependent on the first to fourteenth aspects, the display control unit may perform a control that causes the second content to be non-displayed after the second content and the first content have been displayed.

According to the fifteenth aspect, the display control unit causes the second content to be non-displayed after the second content and the first content are displayed, which makes it possible to reduce the amount of content occupying the display angle of view, which can also lead to a reduction in the user's viewing burden.

Those skilled in the art will readily understand that the exemplified aspects according to the present invention may be modified without departing from the spirit of the present invention.

### BRIEF DESCRIPTION OF THE DRAWINGS

FIG. 1(a) is a diagram schematically showing a HUD to which a display control device of an embodiment of the present invention is applied, which is mounted on a vehicle, and FIG. 1(b) is a cross-sectional view of the main parts showing the internal configuration.

FIG. 2 is a block diagram showing the configuration of a display control system using a display control device of an embodiment of the present invention.

FIG. 3 is a flowchart showing an operation of a display control system to which a display control device of an embodiment of the present invention is applied.

FIG. 4 is a diagram showing a display example (1) of content generated by a display control device of an embodiment of the present invention.

FIG. 5 is a diagram showing a display example (2) of content generated by a display control device of an embodiment of the present invention.

FIG. 6 is a diagram showing a display example (3) of content generated by a display control device of an embodiment of the present invention.

FIG. 7 is a diagram showing a display example (4) of content generated by a display control device of an embodiment of the present invention.

FIG. 8 is a diagram showing a display example (5) of content generated by a display control device of an embodiment of the present invention.

FIG. 9 is a diagram showing a display example (6) of content generated by a display control device of an embodiment of the present invention.

FIG. 10 is a diagram showing a display example (7) of content generated by a display control device of an embodiment of the present invention.

### MODE FOR CARRYING OUT THE INVENTION

The best mode described below is used to facilitate understanding of the present invention. Therefore, those skilled in the art should note that the present invention is not unreasonably limited by the embodiment (hereinafter, referred to as the present embodiment) described below.

Hereinafter, as the present embodiment, an example applied to a HUD mounted on a vehicle (automobile) will be illustrated and described with reference to the accompanying drawings.

### (Configuration of Embodiment)

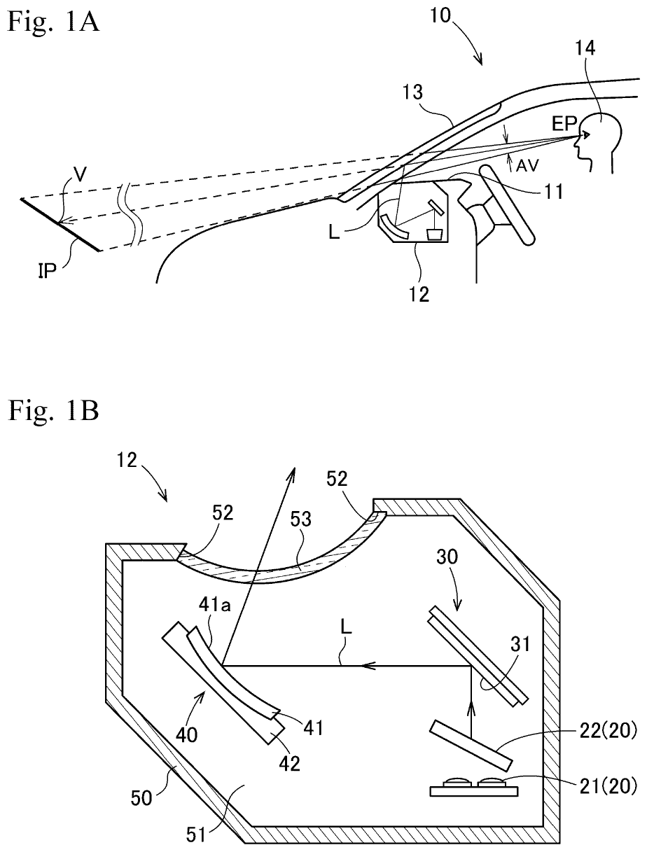

FIG. 1(a) schematically shows a HUD to which the display control device of the present embodiment is applied, which is mounted on a vehicle, and FIG. 1(b) shows a cross-sectional view of the main parts showing the internal configuration of the HUD.

In a projection display by the HUD, as shown in FIG. 1(a), a HUD 12, which is a display device, provided inside an instrument panel 11 of a vehicle 10 projects a display light L, which is reflected by a windshield 13 of the vehicle 10 in the direction of a user (a driver seated in the driver's seat of the vehicle 10) 14 of the vehicle 10 to display a virtual image V. In other words, the HUD 12 emits (projects) the display light (image) L from a liquid crystal displayer 20 described later onto the windshield 13, which is a projection member, and causes the user to visually recognize the display light (virtual image) V obtained in response to the emission. As a result, the user 14 is capable of observing the virtual image V superimposed on the scenery on the forward side of the vehicle 10.

In this case, the HUD 12 projects the display light L such that the virtual image V is inclined at 45 degrees or less (0 to 45 degrees) with respect to the road surface on which the vehicle 10 is traveling, and an upper portion of the virtual image V appears to be more inclined toward the far side from the user than a lower portion. As a result, the user 14 can visually recognize the virtual image V displayed mainly superimposed on the road surface on the forward side of the vehicle 10, and can obtain various types of information indicated by the content of the image.

In addition, an angle of view (AV) is set to the HUD 12. If a virtual range in space where the virtual image V can be formed by the HUD 12 is defined as an image plane (IP), the angle of view (AV) is a field of view (FOV) defined based on a virtual line connecting the user's eye point (EP) and the outer edge of the image plane (IP). The angle of view (AV) is the angle range within which the user is capable of visually recognizing the virtual image V when viewed from the eye point (EP). In the HUD 12, the horizontal angle of view in the horizontal direction (for example, about 10 to 12°) is made larger than the vertical angle of view in the vertical direction (for example, about 4 to 5°). The forward range that overlaps with the image plane (IP) when viewed from the eye point (EP) becomes the range of the angle of view (AV).

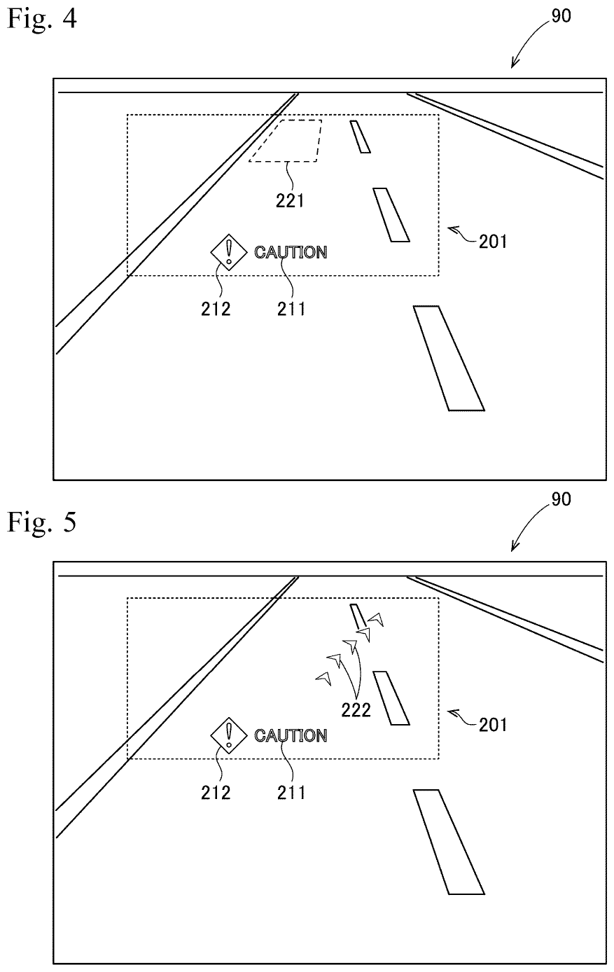

On the display device to which the display control device of the present embodiment is applied (here, the HUD 12), a first content (superimposed content) to be superimposed and displayed on a specific superimposition target present in the actual view, and a second content (non-superimposed content) to be superimposed and displayed on the actual view in a non-superimposed state with respect to the superimposition target, are displayed. Specifically, the HUD 12 displays superimposed content 211, 221 to 223, and 231 (see FIGS. 4 to 10) and non-superimposed content 211 to 217 (see FIGS. 4 to 10) as the virtual image V.

Here, the superimposed content is a visually prominent augmented reality (AR) display object that uses AR, and the display position, for example, is associated with a specific superimposition target present in the foreground, such as a road surface, a forward vehicle, a pedestrian, or a road sign. The superimposed content is superimposed and displayed on a specific superimposition target, and for example, it is conceivable to indicate a dangerous area on a road with a frame line so that the range is communicated to the user (see reference sign 221 in FIGS. 4 to 10 described later), or by filling the inside of a frame line with a color, or to use a three-dimensional representation including the height direction. The superimposed content can move in the user's view so as to follow the superimposition target. That is, the positional relationship between the user's eye point (EP), the superimposition target in the foreground, and the superimposed content is continuously maintained.

On the other hand, the non-superimposed content is a non-AR display object among the display objects superimposed and displayed on the foreground, other than the superimposed content. The non-superimposed content, unlike the superimposed content, is superimposed and displayed on the foreground in a non-superimposed state with respect to a specific superimposition target. The display position of the non-superimposed content is not associated with a specific superimposition target. The non-superimposed content is displayed so as to be relatively fixed to a vehicle component such as the windshield 13, without following a specific superimposition target. Note that, due to the positional relationship between the vehicle 10 and the superimposition target, even the non-superimposed content can sometimes be temporarily superimposed on the superimposition target.

As shown in FIG. 1(b), the HUD 12 is mainly composed of a liquid crystal displayer 20, a first reflector 30, a second reflector 40, and a housing 50.

The liquid crystal displayer 20 is mainly composed of a light source 21 consisting of light-emitting diodes mounted on a wiring board, and a thin film transistor liquid crystal (TFT) type liquid crystal display element 22 positioned on the emission side (directly above) of the light source 21 so as to form a display light L by transmitting illumination light from the light source 21. This means that the light source 21 is provided behind the liquid crystal display element 22, and the liquid crystal display element 22 displays a predetermined image with the light emitted from the light source 21.

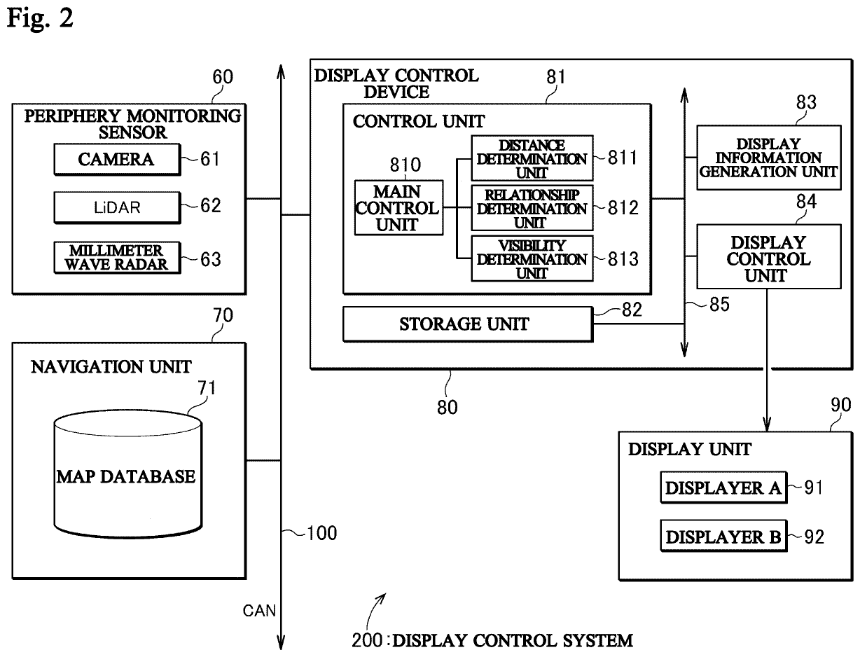

Furthermore, the liquid crystal displayer 20 outputs a display light L consisting of light in the visible wavelength range, and for example, a light source 21 that emits white light can be applied, and a display light L including a desired image is output as a result of the liquid crystal display element 22 transmitting the light emitted from the light source 21. The liquid crystal display element 22 forms a desired image based on display image data (drive signal) generated by a drawing calculation performed by a display control device 80 (see FIG. 2) described later. The display control device 80 generates image data to be displayed based on vehicle information input from the vehicle 10 via communication, and causes the liquid crystal display element 22 to display the image data.

The first reflector 30 includes a cold mirror 31. The cold mirror 31 reflects light in the visible wavelength range (450 to 750 nm), including the emission wavelength range of the liquid crystal displayer 20, with a high reflectance of, for example, 80% or more, and reflects light outside the visible wavelength range with a low reflectance. In this case, a cold mirror 31 is applied that reflects light outside the visible wavelength range, particularly light in the infrared wavelength range (heat rays from external light such as sunlight), with a low reflectance of, for example, 15% or less. Note that light that is not reflected by the reflective layer of the cold mirror 31 is configured to pass through the cold mirror 31. The cold mirror 31 can suppress the liquid crystal display element 22 from being heated by sunlight or the like and becoming a high temperature.

The second reflector 40 includes a concave mirror 41 that reflects the display light L from the cold mirror 31 (that is, the liquid crystal display element 22), and a mirror holder 42 that holds the concave mirror 41.

The concave mirror 41 has a second reflective layer 41a formed by vapor deposition on a resin substrate made of polycarbonate having a concave surface. The concave mirror 41 is provided in an inclined position where the second reflective layer 41a faces the cold mirror 31 and a translucent cover, and is visible from the translucent cover.

Moreover, the concave mirror 41 also magnifies the display light L from the cold mirror 31 while reflecting (projecting) the light toward the translucent cover (the windshield 13 of the vehicle 10) side. This means that the concave mirror 41 magnifies the display light L reflected by the cold mirror 31, and projects the magnified display light L onto the windshield 13 through the translucent cover. Note that the concave mirror 41 is adhered to the mirror holder 42 by a double-sided adhesive member. The mirror holder 42 is made of, for example, a synthetic resin such as acrylonitrile butadiene styrene (ABS), and is fixed to the housing 50.

The housing 50 is made of, for example, a black light-shielding synthetic resin material, is formed in a substantially box shape, holds and accommodates a projection unit consisting of the liquid crystal displayer 20, the first reflector 30, and the second reflector 40 in a space portion 51, which is the internal space thereof, and is provided with an opening window portion 52 that opens at an upper portion (windshield 13 side) of the concave mirror 41 in the second reflector 40.

Furthermore, the housing 50 is provided with a translucent cover 53, which is an emission portion, so as to close the opening window portion 52. The translucent cover 53 uses a translucent synthetic resin material (for example, acrylic resin), is formed in a curved shape (curved surface shape), and has a function as a light-transmitting member through which the display light L reflected by the concave mirror 41 is transmitted (passes through). In other words, the display light L reflected by the cold mirror 31 and the concave mirror 41, that is, the display light L output by the projection unit, is projected onto the windshield 13 through the translucent cover 53 formed on the housing 50, and causes the virtual image V to be displayed.

The HUD 12 projects and outputs to the lower side of the windshield 13. For this reason, from the user 14 side, the virtual image V can be seen superimposed on the forward scenery from a lower area of the windshield 13. Therefore, the user 14 mainly sees the virtual image V displayed on the road surface near the vehicle 10. In addition, due to the configuration of the projection unit of the HUD 12, a virtual image Vis output in which an upper portion of the output image appears to be more inclined toward the far side from the vehicle 10 than a lower portion.

FIG. 2 is a block diagram showing the configuration of a display control system 200 using a display control device 80 of the present embodiment.

As shown in FIG. 2, the display control system 200 is configured to include a periphery monitoring sensor 60, a navigation unit 70, the display control device 80 of the present embodiment, and a display unit 90.

The periphery monitoring sensor 60 is a sensor that is necessary for recognizing the surrounding driving environment including the forward side of the vehicle 10, and includes at least a camera 61, a light detection and ranging (LiDAR) 62, and a millimeter wave radar 63. The detection information that has been detected by the periphery monitoring sensor 60 is transferred to the navigation unit 70 and the display control device 80 of the present embodiment via a control area network (CAN) 100, which is an in-vehicle LAN.

The camera 61 captures at least the forward field of view (actual view) of the vehicle 10, and the LiDAR uses near-infrared light, visible light, or ultraviolet light, for example, to irradiate light with respect to an obstacle or the like that is present on the forward side of the vehicle 10 that has been captured by the camera 61, captures the reflected light with a light sensor, and determines the distance to the obstacle based on the time difference thereof. Furthermore, the millimeter wave radar 63 uses a frequency band of 30 GHz to 300 GHz (EHF: Extra High Frequency) and, in a similar manner to the LiDAR 62, determines the distance to an obstacle by remote sensing.

The navigation unit 70 uses a global navigation satellite system (GNSS), such as a global positioning system (GPS), and a gyro sensor to obtain map information from a recording medium or via wireless communication with the outside of the vehicle, and provides guidance about the facilities around the vehicle 10, route guidance, and the like. The navigation unit 70 transfers a signal that prompts a display output based on the guidance information at an appropriate timing to the display unit 90 via the CAN 100 and the display control device 80.

The navigation unit 70 includes a map database (map DB 71). The map database 71 acquires and stores the latest map information by, for example, communication with an external center (not shown) via a vehicle-to-X (V2X) type communication system (not shown). Here, the map information stored in the map database 71 is mapping data which is digitized to represent the traveling environment of the vehicle 10. The mapping data is particularly preferably digital data of a high-accuracy dynamic map. A “dynamic map” is a digital map obtained by combining a large amount of dynamic information that changes every moment, such as traffic regulations, construction information, accidents, congestion, pedestrians, and signal information, as well as static information such as high-accuracy three dimensional position information (road surface information, traffic lane information, and three dimensional structures).

Although not shown, a driving assistance electronic control unit (ECU) that assists the user's driving is also connected to the CAN 100. The driving assistance ECU has at least one of a driving assistance function that assists the user's driving operations, and an automatic driving function that can substitute for the user's driving operation, and can recognize the driving environment on the forward side of the vehicle 10 based on the detection information acquired from the periphery monitoring sensor 60, and in addition to controlling the vehicle 10 according to an analysis result of the recognized detection information, is capable of transferring the analysis result of the detection information to the control device 80 via the CAN 100.

The display control device 80 generates a first content (superimposed content) to be superimposed and displayed on a specific superimposition target (such as a road surface, a forward vehicle, a pedestrian, or a road sign) present in the actual view, and a second content (non-superimposed content) to be superimposed and displayed on the actual view in a non-superimposed state with respect to the superimposition target, and sequentially displays the superimposed content and the non-superimposed content on the display unit 90. For this reason, the display control device 80 includes a control unit 81, a storage unit 82, a display information generation unit 83, and a display control unit 84.

The control unit 81, based on the superimposition target captured by the periphery monitoring sensor 60, determines a distance between an own vehicle position and the superimposition target, determines a relationship between the superimposed content and the non-superimposed content, and further, determines a visibility of the forward field of view of the vehicle 10. For this reason, the control unit 81 includes a main control unit 810, a distance determination unit 811, a relationship determination unit 812, and a visibility determination unit 813.

The main control unit 810 manages the interface with the periphery monitoring sensor 60 and the navigation unit 70, and for example, based on the information monitored by the periphery monitoring sensor 60, recognizes information relating to superimposition targets such as a road surface, a forward vehicle, a pedestrian, and a road sign, and also acquires, from the map database 71 held by the navigation unit 70, static information such as high-accuracy three-dimensional position information (road surface information, traffic lane information, and three-dimensional structure information) and dynamic information such as weather that changes from moment to moment, and transfers the information to the distance determination unit 811, the relationship determination unit 812, and the visibility determination unit 813.

The distance determination unit 811 determines the distance between the own vehicle position and the superimposition target, the relationship determination unit 812 determines the relationship between the superimposed content and the non-superimposed content, and the visibility determination unit 813 determines the visibility of the forward field of view of the vehicle 10. The distance information determined by the distance determination unit 811, the relationship level information determined by the relationship determination unit 812, and the visibility level information determined by the visibility determination unit 813 are all output (written) to the storage unit 82 via an internal bus 85 configured by a plurality of lines for addressing, data, and control.

In the storage unit 82, for content generation and display, a storage area that stores the entire content including the superimposed content and non-superimposed content, and a video RAM (VRAM) storage area are respectively allocated, and is composed of, for example, dynamic random access memory (DRAM), static RAM, or the like.

The display information generation unit 83 generates superimposed content to be superimposed and displayed on a specific superimposition target that is present in the actual view, and non-superimposed content to be superimposed and displayed on the actual view in a non-superimposed state with respect to the superimposition target, associates the content with display attributes (display position, display color, and display start timing setting information described later), and transfers the information to the storage unit 82 via the internal bus 85 (written to a predetermined area of the control unit 81).

The display control unit 84 reads the superimposed content and the non-superimposed content from the storage unit 82, and then sequentially displays the content on the display unit 90. Here, the non-superimposed content is displayed first, and then the superimposed content is displayed. Specifically, the display control unit 84 reads the superimposed content and non-superimposed content written in a predetermined area of the storage unit 82, draws the content according to display attribute information (such as the display position and display color) stored corresponding to the content in the VRAM allocated in another area in synchronization with the refresh rate, and then displays the content on the display unit 90 by sequentially reading the content from the VRAM in synchronization with the display start timing.

The display control unit 84 displays the non-superimposed content and then the superimposed content on the display unit 90, even in a situation where the superimposed content can be superimposed on the superimposition target. In addition, the display control unit 84 displays the superimposed content further away than the non-superimposed content in a user's view.

Here, the display unit 90 used as a display device has, for example, a displayer A (first displayer) 91 and a displayer B (second displayer), and the display control unit 84 may display the superimposed content on the displayer A (91) and display the non-superimposed content on the displayer B (92). Here, the displayer A (91) is, for example, the HUD 12 shown in FIGS. 1(a) and 1(b), and the displayer B (92) is, for example, a WSD that projects an image onto the black ceramic portion of the vehicle (a black part of the windshield).

Furthermore, the display control unit 84 may display the superimposed content in a first mode (for example, a frame line 221 that encloses the superimposition target shown in FIG. 4, described later) and display the non-superimposed content in a second mode (for example, text 211 and an icon 212 shown in FIG. 4, described later).

Also, when a first superimposed content (for example, reference sign 221 in FIG. 9, described later) displayed corresponding to a first superimposition target among specific superimposition targets for which the relationship level indicating the relationship between the superimposed content and the non-superimposed content output by the relationship determination unit 812 is less than a predetermined value, and a second superimposed content (for example, reference sign 223 in FIG. 9, described later) displayed corresponding to a second superimposition target, which is a specific superimposition target, are displayed simultaneously, the display control unit 84 may perform a control that delays the display start timing of the second superimposed content (223), or advances the display start timing of the first superimposed content (221), or both.

In addition, in a case where the relationship level indicating the relationship between the superimposed content and the non-superimposed content output by the relationship determination unit 812 is greater than or equal to a predetermined value, the display control unit 84 may perform a control that arranges and displays the superimposed content and the non-superimposed content on a straight line that connects the superimposition target and an eye point of the user when viewing the superimposition target from above.

In the determination of the relationship between the superimposed content and the non-superimposed content, for example, the relationship level is determined to be high if the superimposed content and the non-superimposed content are created for a single object being tracked by the periphery monitoring sensor 60. Furthermore, for example, a label can be assigned to each content, and if the matching number of labels between the superimposed content and the non-superimposed content is greater than or equal to a predetermined threshold, it can be determined that the relationship level is high. A method that calculates a correlation coefficient, described later, can also be considered.

Moreover, the display control unit 84 may control the display start timing of the superimposed content according to the visibility level indicating the visibility, which is the output of the visibility determination unit 813 that determines the visibility of the forward field of view of the vehicle 10. Here, the determination of the visibility can be realized by, for example, generating feature amounts for each part that constitutes a specific subject, matching the feature amounts with those of the same subject in a preset, high-visibility situation, and then calculating a score according to the matching result. The visibility of a subject is highest when everything is clearly visible, and the area that is clearly visible is affected and becomes smaller as more of the area becomes obscured by the effects of weather and the like. Therefore, it is possible to estimate the extent to which each part constituting the subject is visible from the score of each part. The visibility can be evaluated using the ratio of the total area of the parts with a high score to the total area of the subject as a quantity representing how much of the subject is visible.

Also, the control of the display start timing can be realized by, for example, providing a range to the display start timing setting (a timing settable range), setting a display start timing that is earlier or later than a standard display start timing, and controlling the rising edge of a blanking period (during the display period of both horizontal/vertical synchronization signals) according to the setting.

Furthermore, the display control unit 84 may control the display start timing of the superimposed content according to the display distance of the non-superimposed content. Here, the display distance of the non-superimposed content is the distance from the eye point EP (FIG. 1(a)) of the user to the non-superimposed content, and the display distance is controlled by at least one of changing the optical path length from the display unit 90 such as an LCD panel with a backlight or the like to the windshield 13 (FIG. 1(a)) serving as the projection member (specifically, the length of the optical path from a first point where the optical axis of the optical system intersects the display surface of the display unit 90 to a second point where the optical axis intersects the windshield 13 serving as the projection member), or changing the display position of the non-superimposed content on the display surface.

In addition, the display control unit 84 may control the display distance interval between the superimposed content and the non-superimposed content according to the display distance of the superimposed content, and may also control the display distance interval between the superimposed content and the non-superimposed content according to the distance between the own vehicle position and the superimposition target determined by the distance determination unit 811. At this time, the display distance interval is controlled by adjusting the display distance of the non-superimposed content according to the relationship level indicating the relationship between the superimposed content and the non-superimposed content as determined by the relationship determination unit 812.

Also, the display control unit 84 may perform a control that, after the non-superimposed content is displayed, causes the non-superimposed content to be non-displayed until the superimposed content is displayed, and may also perform a control that causes the non-superimposed content to be non-displayed after the non-superimposed content and the superimposed content have been displayed.

### (Operation of Embodiment)

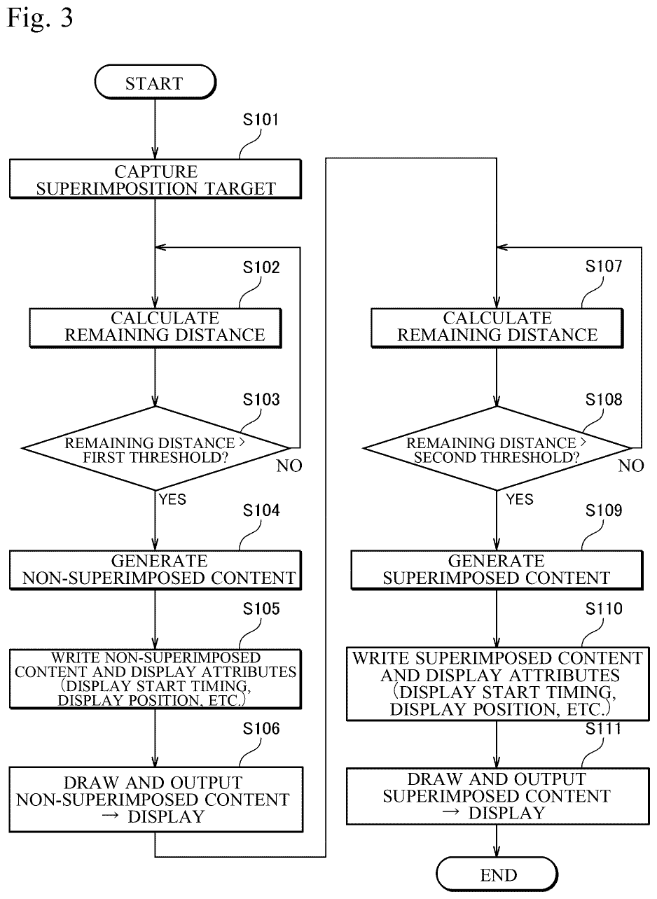

FIG. 3 is a flowchart showing an operation of the display control system 200 to which a display control device 80 of the present embodiment is applied. Furthermore, FIGS. 4 to 10 are content display examples (1) to (7) generated by the display control device 80 of the present embodiment. Note that, the term “content”, unless otherwise specified, refers to content that displays a combination of superimposed content and non-superimposed content.

Hereinafter, the operation of the display control device 80 of the present embodiment shown in FIG. 1 will be described in detail with reference to the flowchart shown in FIG. 3 and the content display examples (1) to (7) shown in FIGS. 4 to 10.

In FIG. 3, the display control system 200 first captures a superimposition target, which is a specific target that is present in the foreground, such as a road surface, a forward vehicle, a pedestrian, or a road sign (step S101). The superimposition target is captured in real time through information exchange via the periphery monitoring sensor 60, which includes the camera 61, the LiDAR 62, and the millimeter wave radar 63, the navigation unit 70, which includes the map database 71 containing map data and a dynamic map, and the CAN 100, and is transferred to the display control device 80 (main control unit 810) via the CAN 100.

Note that the dynamic map referred to here is a dynamic map in a broad sense, and in addition to a dynamic map platform used for autonomous driving, and is also considered to be a dynamic map that includes real-time dynamic information such as weather information and road closures due to construction, as used in map applications. Also, the superimposition target is also assumed to mainly refer to objects that could potentially expose the user to danger, including on-road obstacles and on-road hazardous areas. Examples of on-road hazardous areas include road surface areas that are frozen due to low temperatures, and areas where the road condition has changed from normal state and a danger has occurred, such as road surface areas with severe unevenness, and locations where construction has suddenly occurred.

Next, in the display control device 80, the distance determination unit 811 calculates the remaining distance from the own vehicle position to the superimposition target (step S102). The remaining distance can be grasped by calculating the distance from the superimposition target captured in step S101 to the own vehicle position (which is measured by a GPS or the like included in the navigation unit 70). Here, the remaining distance includes the straight-line distance and the route distance. Also, the distance determination unit 811 may calculate a predicted time of arrival from the route distance and the own vehicle speed (measured by a vehicle speed sensor or the like mounted on the vehicle 10 as a behavior sensor), and determine the display start timing of the content from the predicted time of arrival.

The control of the display start timing can be realized by, for example, providing a range to a display start timing setting (timing settable range), setting a display start timing that is earlier or later than a standard display start timing, and controlling the rising edge of a blanking period (during the display period of both horizontal/vertical synchronization signals) according to the setting.

Next, the distance determination unit 811 determines whether or not the remaining distance is less than a first threshold (step S103). The first threshold here is, for example, 60 m before the superimposition target. This is twice the value of the timing for signaling a right/left turn or lane change, as described in Article 21 of the Enforcement Order of the Road Traffic Act. In terms of the driver's cognitive reaction time, for example, results show that the cognitive reaction time for an object that should be recognized on the road is a maximum of 1.5 seconds among young people and a maximum of 1.8 seconds among the elderly, and because it takes approximately 3.6 seconds for a vehicle traveling at 60 km/h to reach a location that is 60 m ahead, a setting of 60 m before the object as the first threshold is considered reasonable.

Here, if the remaining distance is less than the first threshold (step S103: “YES”), the display information generation unit 83 generates non-superimposed content (step S104). The non-superimposed content generated by the display information generation unit 83 is written, along with the display attributes (such as the display position, display start timing, and display color), to a predetermined area of the storage unit 82 (step S105). Then, the display control unit 84 reads the non-superimposed content written in the predetermined area of the storage unit 82, draws the content according to display attribute information (such as the display position and display color) stored corresponding to the non-superimposed content in the VRAM allocated in another area in synchronization with the refresh rate, and then display the content on the display unit 90, for example, in the form of the display examples (1) to (7) shown in FIGS. 4 to 10 by sequentially reading the content from the VRAM area in synchronization with the display start timing (step S106).

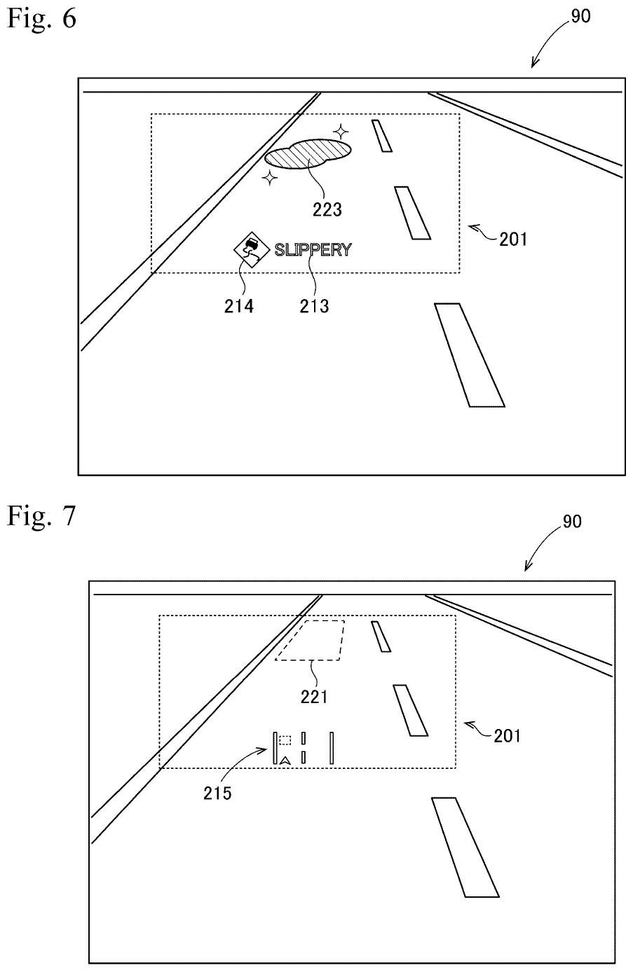

The display examples (1) to (7) of the non-superimposed content will be described with reference to FIGS. 4 to 10. Examples of non-superimposed content include non-superimposed content 211 (FIG. 4) that indicates a danger in a text format. This is a format that notifies that there is a danger without mentioning the details, but also includes formats like non-superimposed content 213 (FIG. 6) that mentions the nature of the danger in addition to the fact that the danger exists. Also, an icon may be displayed that intuitively indicates to the user that there is a danger, in the manner of non-superimposed content 212 (FIGS. 4 and 5). As with the text, the icon also includes formats that notify that there is a danger without mentioning the details, as well as formats that notify the nature of the danger, like non-superimposed content 214 (FIG. 6). In addition, the non-superimposed content is not limited to being displayed alone, and a display format can be adopted that conveys the danger more intuitively to the user by displaying a combination of a plurality of items.

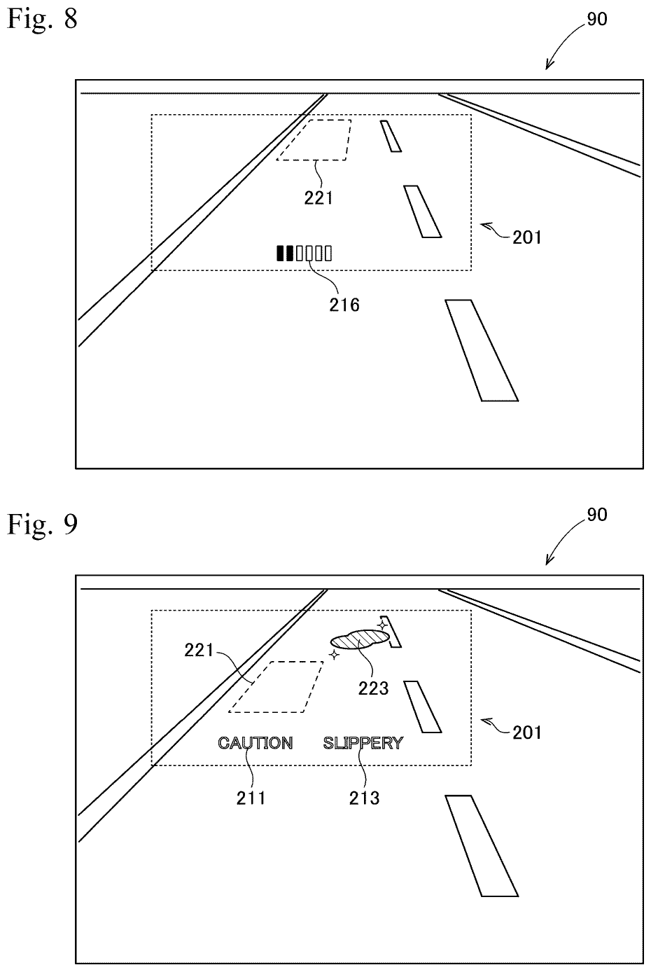

Alternatively, a small-world format, which is a bird's eye view display of the road situation such as non-superimposed content 215 (FIG. 7), is also included. This involves displaying in advance the superimposed content scheduled for display and the own vehicle position, superimposed on a map display showing the planned travel route. Also, a format that displays the grasped remaining distance to the superimposition target with a gauge (elevator icon) in the manner of non-superimposed content 216 (FIG. 8) is also possible.

On the other hand, if it is determined in the remaining distance determination processing of step S103 that the remaining distance is not less than the first threshold (is greater than or equal to the first threshold) (step S103: “NO”), the remaining distance calculation processing of step S102 is repeatedly executed.

Then, the distance determination unit 811 calculates the remaining distance from the own vehicle position to the superimposition target in a similar manner to the remaining distance calculation processing of step S102 (step S107). Then, it is determined whether or not the remaining distance is less than a second threshold (step S108). Here, the second threshold is, for example, 30 m before the superimposition target. This is the value of the timing for signaling a right/left turn or lane change, as described in Article 21 of the Enforcement Order of the Road Traffic Act.

Here, when calculated in the same way as for the first threshold, it takes approximately 1.8 seconds for a vehicle traveling at 60 km/h to reach a location 30 m ahead. This matches the cognitive reaction time to an object on the road that should be recognized of 1.8 seconds, which is the maximum value among the elderly. In reality, it is conceivable that the user has detected the danger in advance due to the display of the non-superimposed content and is driving at a reduced speed, and therefore, the distance is considered to be a manageable threshold.

If it is determined in the remaining distance determination processing of step S108 that the remaining distance is less than the second threshold (step S108: “YES”), the display information generation unit 83 generates superimposed content (step S109). The non-superimposed content generated by the display information generation unit 83 is written, along with the display attributes (such as the display position, display start timing, and display color), to a predetermined area of the storage unit 82 (step S110). Then, the display control unit 84 reads the superimposed content written in a predetermined area of the storage unit 82, draws the content according to display attribute information (such as the display position and display color) stored in the storage unit 82 corresponding to the superimposed content in the VRAM allocated in another area in synchronization with the refresh rate, and then display the content on the display unit 90, for example, in the form of the display examples (1) to (7) shown in FIGS. 4 to 10 by sequentially reading the content from the VRAM in synchronization with the display start timing (step S111).

On the other hand, if it is determined in the remaining distance determination processing of step S108 that the remaining distance is not less than the second threshold (is greater than or equal to the second threshold) (step S108: “NO”), the remaining distance calculation processing of step S107 is repeatedly executed.

Here, superimposed content display examples (1) to (7) will be described with reference to FIGS. 4 to 10. Examples of the superimposed content include superimposed content 221 (FIGS. 4, 7 to 10) that indicates a dangerous area on a road. The superimposed content is superimposed content that conveys the range of the superimposition target to the user, and is not limited to an expression that presents only a frame line (FIGS. 4, 7 to 10), and may also be implemented as an expression that fills the inside of the frame line with a color, or a three-dimensional expression that includes a height direction. In addition, a display mode that does not indicate a dangerous area but instead draws a route that enables the dangerous area to be avoided may be drawn, as indicated by superimposed content 222 (FIG. 5).

Alternatively, in addition to indicating the danger range such as by superimposed content 221 (FIGS. 4, 7 to 10), an expression that allows the nature of the danger to be intuitively understood, like superimposed content 223 (FIG. 9), may also be used. The superimposed content 223 shown in FIG. 9 is an example of an intuitive expression indicating danger with respect to freezing of the road surface. Also, in addition to still images, it is also possible to provide an expression that can be more intuitively understood by presenting an animation.

The display examples (1) to (7) shown in FIGS. 4 to 10 are display examples combining superimposed content and non-superimposed content, and the superimposed content is displayed further away than the non-superimposed content in the user's view. As a result, by using a mode where the user views a near location and then shifts the line of sight to a far location, it is possible to smoothly reduce the number of reciprocating line of sight movements.

Here, even in a situation where the superimposed content can be superimposed on the superimposition target, it is possible to firstly display the non-superimposed content, and then display the superimposed content. For example, in a scene where the periphery monitoring sensor 60 has captured a superimposition target, if another vehicle cuts in between the vehicle 10 and the superimposition target, the correspondence with the superimposition target will be lost even if the superimposed content is displayed, and therefore, the effect of the present invention cannot be ensured. Therefore, by displaying the non-superimposed content first, it becomes possible to provide advance information notification in a form that is easy for the user to understand.

Furthermore, the superimposed content, due to the characteristic of being displayed so as to visually overlap with the superimposition target, is highly likely to be displayed in the upper part of the display area 201 (FIGS. 4 to 10). Therefore, it is preferable to display the non-superimposed content in the lower part of the display area 201 in order to avoid the display area 201 from becoming cluttered with content. For example, if the content indicating a speedometer that displays the speed of the own vehicle has a character height of 0.54° and is drawn at the bottom end of the display area 201, the area of 0.54° in the vertical direction at the bottom end of the display area 201 may be used as the area that displays the non-superimposed content.

Moreover, a configuration may also be adopted in which the relationship determination unit 812 determines the relationship between the superimposed content and the non-superimposed content, and the display control unit 84 controls the display timing and display position of the superimposed content and the non-superimposed content according to the relationship level that indicating the relationship. For example, as shown in FIG. 9, in a situation where non-superimposed content 211 and superimposed content 221, which notify information relating to a superimposition target a (first superimposition target), and non-superimposed content 213 and superimposed content 223, which notify information relating to a superimposition target b (second superimposition target), are displayed, the relationship level is determined to be low because the superimposition target a and the superimposition target b are different. In FIG. 9, if there is a possibility that the superimposed content 221 and the non-superimposed content 213 will be displayed simultaneously, the display control unit 84 performs a control that delays the display start timing of the non-superimposed content 213 or advances the display start timing of the superimposed content 221.

In the determination of the relationship level, as described above, the relationship level determined to be high if the superimposed content and the non-superimposed content are generated for a single object being captured by the periphery monitoring sensor 60. Also, for example, a method is conceivable in which a label is assigned to each content, and if the matching number of labels between the superimposed content and the non-superimposed content is greater than or equal to a predetermined threshold, the relationship level is determined to be high.

Alternatively, a method of calculating a correlation coefficient can also be considered. In this case, for example, the number of times each content is displayed in a certain section is calculated, and after performing the calculation with respect to a plurality of sections, the correlation coefficient is calculated for all combinations of the superimposed content and the non-superimposed content. The combinations for which the absolute value of the correlation coefficient is greater than or equal to a predetermined threshold is determined to have a high relationship level. The following equation is an equation that derives a correlation coefficient, where r is the correlation coefficient, x is the number of times the superimposed content is displayed, and y is the number of times the non-superimposed content is displayed.

$$[ Math . 1 ]$$

$$r = \frac{\frac{1}{n} {\sum }_{i = 1}^{n} ( {x}_{i} - \overline{x} ) ( {y}_{i} - \overline{y} )}{\sqrt{\frac{1}{n} {\sum }_{i = 1}^{n} {( {x}_{i} - \overline{x} )}^{2}} \times \sqrt{\frac{1}{n} {\sum }_{i = 1}^{n} {( {y}_{i} - \overline{y} )}^{2}}} \qquad ( 1 )$$

When the relationship level is greater than or equal to the predetermined threshold, as a result of the display control unit 84 arranging and displaying the superimposed content and the non-superimposed content on a straight line that connects the user's eye point EP (FIG. 1(a)) when viewing the superimposition target from above (the user visually recognizes the first content and the second content in a single line), the movement of the user's line of sight becomes natural, and the relationship between the content can be made visually easy to understand. In other words, the movement in the user's gaze point is reduced as much as possible when the user's focus point switches from the forward actual view to the virtual image (the need for eye focus adjustment is reduced as much as possible).

Furthermore, the display start timing of the superimposed content may be determined according to the display distance of the non-superimposed content. For example, if the display distance of the non-superimposed content is short, the display start timing of the superimposed content is delayed. If the non-superimposed content is at a short distance and the superimposed content is displayed immediately, the line of sight movement from the non-superimposed content to the superimposed content will become excessively large, and it is expected that the user's visibility load will increase from the viewpoint of convergence adjustment and focus adjustment. For this reason, in a case where the display distance of the non-superimposed content is short, the visibility load can be reduced by delaying the display start timing of the superimposed content.

Here, for example, a method is conceivable in which, when the non-superimposed content is displayed at a display distance less than a predetermined threshold, the superimposed content is displayed with a delay of a predetermined number of seconds. Also, the display start timing of the superimposed content may be delayed by reducing the second threshold in the “remaining distance determination processing” of step S108.

In addition, the display start timing of the superimposed content may be determined according to the visibility (visibility level) of the forward field of view determined by the visibility determination unit 813. For example, a situation is conceivable in which the user's external visibility is reduced due to weather changes such as rain or snow. In such a situation, the superimposition target cannot be seen until the last moment, and if the information notification by the superimposed content is given at the last moment, it may lead to user disturbance. Therefore, as a result of the display control unit 84 performing a control that advances the display start timing of the superimposed content, it becomes possible to prepare for danger in advance while reducing the user's mental load.

Also, a situation is conceivable in which a forward vehicle is traveling in a way that obstructs (interferes with) the user's field of view, and the superimposition target cannot be visually recognized. In such a situation, as described above, since there is a possibility that the superimposition target cannot be visually recognized until the last moment, the display control unit 84 can execute processing that advances the display start timing of the superimposed content.

Further, the display distance interval between the superimposed content and the non-superimposed content may be determined according to the display distance of the superimposed content. For example, after the superimposition target is captured by the periphery monitoring sensor 60 and the display distance of the superimposed content is determined, the display distance of the non-superimposed content is determined, and the display distance interval is determined. Here, when the display distance of the superimposed content is d1 and the display distance of the non-superimposed content is d2, the display control unit 84 may perform a control such that, if the relationship level determined by the relationship determination unit 812 is high, the value of the display distance d2 of the non-superimposed content is increased to narrow the display distance interval, while if the information relationship level is low, the value of the display distance d2 of the non-superimposed content is decreased to widen the display distance interval. This is to visually separate items with a low relationship level, and to implement notifications that do not mislead the user.

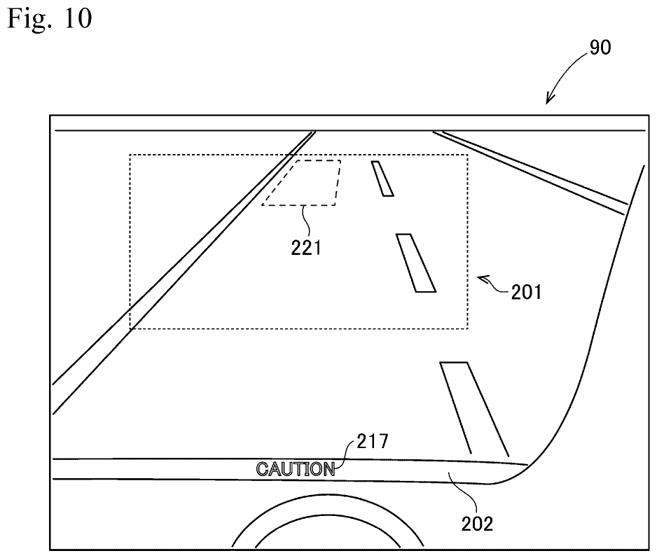

When the display unit 90 that displays the superimposed content is the displayer A (91), the non-superimposed content may be displayed using the displayer B (92), which is different from the displayer A (91). The display example (10) in such a case is shown in FIG. 10. Here, a combination is conceivable where the displayer A (91) is a HUD, and the displayer B (92) is a WSD that makes it possible to project an image onto the black ceramic portion of the vehicle. In this case, as shown in FIG. 10, the superimposed content is displayed in the display area 201 and the non-superimposed content is displayed in the display area 202, respectively. As a result of displaying the superimposed content and the non-superimposed content in different display areas, it is possible to realize a display format that ensures the effects of the present invention while reducing the clutter of content within a single display area.

### (Effects of Embodiment)

As described above, according to the display control device 80, the display control unit 84 sequentially displays, on the display device, the superimposed content (first content), which is superimposed and displayed on a specific superimposition target present in the actual view, and the non-superimposed content (second content), which is superimposed and displayed on the actual view in a non-superimposed state with respect to the superimposition target. In this way, the amount of information provided to the user is distributed by the superimposed content and the non-superimposed content, and the superimposed content and the non-superimposed content are displayed in a stepwise fashion. As a result, for example, in a driving situation where a danger occurs, it is possible to notify the user of the danger in an easily-understandable manner with less burden on the user, thereby allowing the user to prepare for the danger.

Furthermore, according to the display control device 80 of the present embodiment, the display control unit 84 displays the superimposed content after displaying the non-superimposed content. In this way, by providing advance notification with non-superimposed content having substantially the same meaning as the superimposed content, instead of the visually prominent superimposed content, it is possible to transmit the necessary information while ensuring forward visibility for the user. Therefore, it is possible to allow the user to prepare for danger by, for example, notifying the user of a dangerous situation in advance an easily-understandable manner.

In addition, according to the display control device 80 of the present embodiment, if the visually prominent superimposed content is displayed first, the user will become less alert to other objects, and therefore, by displaying the non-superimposed content first, the user is capable of accepting information while distributing the attention to some extent. Moreover, by adopting a mode in which the user's line of sight moves from the non-superimposed content, which is displayed nearby in the user's view, to the superimposed content, which is displayed in the distance, the number of reciprocating line of sight movements can be reduced, which enables smooth viewing that facilitates easier understanding known to the user.

Furthermore, according to the display control device 80 of the present embodiment, the display device (display unit 90) has the first displayer (displayer A (91)) and the second displayer (displayer B (92)), and the display control unit 84 displays the superimposed content on the displayer A (91) and displays the non-superimposed content on the displayer B (92). For example, by using a HUD as the displayer A (91) and a WSD that projects an image onto the black ceramic portion of the vehicle (the black part of the windshield) as the displayer B (92), a wide display area for the content can be obtained, and it is also possible to prevent the display from becoming complicated.

Also, according to the display control device 80 of the present embodiment, the display control unit 84 provides advance notification with the non-superimposed content using text, icons, and the like, thereby allowing the user to understand, for example, the nature of the danger in advance.

In addition, according to the display control device 80 of the present embodiment, when the superimposed content of a certain superimposition target and the non-superimposed content of another superimposition target are displayed simultaneously, the display control unit 84 performs a control to delay the display start timing of the non-superimposed content, or advance the display start timing of the superimposed content, or both, thereby making it possible to prevent the user from being misled into thinking that the content are related.

Moreover, according to the display control device 80 of the present embodiment, when the user views the superimposed content or the non-superimposed content from the actual view on the forward side of the vehicle, the user is required to direct the focus of the eyes (gaze point) from the actual view in real space to a virtual image, but when the relationship level is greater than or equal to the predetermined threshold, the display control unit 84 arranges and displays the superimposed content and the non-superimposed content on a straight line that connects the user's eye point EP when viewing the superimposition target from above (the user visually recognizes the superimposed content and the non-superimposed content in a single line), the movement of the user's line of sight becomes natural, and the relationship between the content can be made visually easy to understand. In other words, the movement in the user's gaze point is reduced as much as possible when the user's focus point switches from the forward actual view to the virtual image (the need for eye focus adjustment is reduced as much as possible).

Furthermore, according to the display control device 80 of the present embodiment, for example, in a situation where the user's visibility is reduced due to weather changes such as rain or snow, although the superimposition target cannot be seen until the last moment, under such circumstances, the display control unit 84 performs a control to advance the display start timing of the superimposed content (in other words, advance the timing of information notification), which makes it possible to prepare for an impending danger in advance while reducing the user's mental burden. Moreover, the display control unit 84 determines the display start timing of the superimposed content according to the display distance of the non-superimposed content, which makes it possible to set a display start timing at which the line of sight movement from the non-superimposed content to the superimposed content does not become excessively large, and as a result, the user's viewing burden (burden of user's eye focus adjustment) can be reduced.

In addition, according to the display control device 80 of the present embodiment, the display control unit 84 controls the display distance interval between the superimposed content and the non-superimposed content according to the display distance of the superimposed content, which makes it possible to set a display distance interval in which the line of sight movement from the non-superimposed content to the superimposed content does not become excessively large, and as a result, the user's viewing burden (burden of user's eye focus adjustment) can be reduced. Also, the display control unit 84 controls the display distance interval between the superimposed content and the non-superimposed content according to the distance between the own vehicle position and the superimposition target, which makes it possible to set a display distance interval in which the line of sight movement from the non-superimposed content to the superimposed content does not become excessively large, and as a result, the user's viewing burden (burden of user's eye focus adjustment) can be reduced.

Furthermore, according to the display control device 80 of the present embodiment, for example, in a case where the display distance of the superimposed content is d1 and the display distance of the non-superimposed content is d2, the display control unit 84 adjusts the display distance of the non-superimposed content such that, if the relationship level between the superimposed content and the non-superimposed content is high, the value of d2 is increased to narrow the display distance interval, and if the relationship level is low, the value of d2 is decreased to widen the display distance interval. As a result, items in which the relationship between the superimposed content and the non-superimposed content is low are visually separated, and notifications that do not mislead the user can be realized.

In addition, according to the display control device 80 of the present embodiment, the display control unit 84, after the non-superimposed content is displayed, causes the non-superimposed content to be non-displayed until the superimposed content is displayed, which makes it possible to reduce the amount of content occupying the display angle of view, which can also lead to a reduction in the user's viewing burden. Also, the display control unit 84 causes the non-superimposed content to be non-displayed after the non-superimposed content and the superimposed content are displayed, which makes it possible to reduce the amount of content occupying the display angle of view, which can also lead to a reduction in the user's viewing burden.

### (Modifications)

Note that, in the display control device 80 of the present embodiment, the distance determination unit 811, the relationship determination unit 812, and the visibility determination unit 813 have been described as being included in the control unit 81 within the display control device 80, but at least one of the units may be substituted by a configuration in which the unit is included in the navigation unit 70 or a driving assistance ECU (electronic control unit) (not shown). In this case, the load on the display control device 80 is reduced.

Furthermore, the functions included in the control unit 81 described above can be realized by a program, being a program that causes a computer to function, that causes the computer to function as each of the functional blocks 810 to 813. In this case, the control unit 81 includes, as hardware for executing the program described above, a computer including at least one control device (such as a processor), at least one storage device (such as a RAM), and a peripheral control LSI (such as the display information generation unit 83 and the display control unit 84). By executing the program described above with such a control device, storage device, and peripheral control LSI, the control provided to each functional block described in the display control device 80 of the present embodiment can be realized.

Also, the program described above may be recorded, not temporarily, on one or more computer-readable recording media. The recording medium may or may not be provided in the control unit 81. In the latter case, the program described above may be supplied to the control unit 18 described above via an arbitrary wired or wireless transmission medium.

Also, at least a part of the above-described functions possessed by each control block can be realized by a logic circuit. For example, an integrated circuit in which a logic circuit that functions as each of the above-mentioned functional blocks is formed is also included in the scope of the present invention. In addition, for example, it is also possible to realize the functions of each functional block by a quantum computer. Further, the processing described in the present embodiment may be executed by artificial intelligence (AI). In this case, the AI may operate in the control unit 81 of the present embodiment, or may operate in another device (such as a cloud server).

The present invention is not limited to the exemplary embodiments described above, and a person skilled in the art can easily modify the exemplary embodiments described above to the extent that they fall within the scope of the claims.

### DESCRIPTION OF REFERENCE NUMERALS

10 Vehicle
12 HUD
13 Windshield
20 Liquid crystal displayer
60 Periphery monitoring sensor
61 Camera
62 LiDAR
63 Millimeter wave radar
70 Navigation unit
71 Map database
80 Display control device
81 Control unit
82 Storage unit
83 Display information generation unit
84 Display control unit
85 Internal bus
90 Display unit
91 Displayer A
92 Displayer B
100 CAN
810 Main control unit
811 Distance determination unit
812 Relationship determination unit
813 Visibility determination unit
200 Display control system

1. A display control device that controls a display device that displays content so as to be superimposed on an actual view, the display control device comprising:
a display information generation unit that generates a first content to be superimposed and displayed on a specific superimposition target present in the actual view, and a second content to be superimposed and displayed on the actual view in a non-superimposed state with respect to the superimposition target; and
a display control unit that sequentially displays the first content and the second content on the display device.

2. The display control device according to claim 1, wherein
the display control unit displays the second content, and then displays the first content.

3. The display control device according to claim 1, wherein
the display control unit, even in a situation where the first content can be superimposed on the superimposition target, displays the second content and then displays the first content.

4. The display control device according to claim 1, wherein
the display control unit displays the first content further away than the second content in a user's view.

5. The display control device according to claim 1, wherein
the display device has a first displayer and a second displayer, and
the display control unit displays the first content on the first displayer and displays the second content on the second displayer.

6. The display control device according to claim 1, wherein
the display control unit displays the first content in a first mode, and displays the second content in a second mode.

7. The display control device according to claim 1, comprising a relationship determination unit that determines a relationship between the first content and the second content, wherein
the display control unit,
in a case where the first content displayed corresponding to a first superimposition target among the specific superimposition targets, and the second content displayed corresponding to a second superimposition target, which is a specific superimposition target, for which a relationship level indicating the relationship is less than a predetermined value, are displayed simultaneously, performs a control that delays a display start timing of the second content and/or advances a display start timing of the first content.

8. The display control device according to claim 1, comprising
a relationship determination unit that determines a relationship between the first content and the second content, wherein
the display control unit, in a case where a relationship level indicating the relationship is greater than or equal to a threshold, arranges and displays the first content and the second content on a straight line that connects the superimposition target and an eye point of a user when viewing the superimposition target from above.

9. The display control device according to claim 1, comprising
a visibility determination unit that determines a visibility of a forward field of view of a vehicle, wherein
the display control unit controls a display start timing of the first content according to a visibility level indicating the visibility.

10. The display control device according to claim 1, wherein
the display control unit controls a display start timing of the first content according to a display distance of the second content.

11. The display control device according to claim 10, wherein
the display control unit controls a display distance interval between the first content and the second content according to a display distance of the first content.

12. The display control device according to claim 11, comprising
a distance determination unit that determines a distance between an own vehicle position and the superimposition target, wherein
the display control unit controls a display distance interval between the first content and the second content according to a distance determined by the distance determination unit.

13. The display control device according to claim 11, comprising
a relationship determination unit that determines a relationship between the first content and the second content, wherein
the display control unit controls the display distance interval by adjusting a display distance of the second content according to a relationship level that indicates the relationship.

14. The display control device according to claim 1, wherein
the display control unit, after the second content is displayed, performs a control that causes the second content to be non-displayed until the first content is displayed.

15. The display control device according to claim 1, wherein
the display control unit performs a control that causes the second content to be non-displayed after the second content and the first content have been displayed.
